(19) United States
(12) Patent Application Publication
(10) Pub. No.: US 2010/0086702 A1
(43) Pub. Date: Apr. 8, 2010

(54) METHODS AND MATERIALS FOR LASER CLADDING

(75) Inventors: George D. BLANKENSHIP, Chardon, OH (US); William T. MATTHEWS, Chesterland, OH (US); Steven R. PETERS, Huntsburg, OH (US); Patrick S. WAHLEN, Jupiter, FL (US)

Correspondence Address: HAHN LOESER / LINCOLN, ONE GOJO PLAZA, SUITE 300, AKRON, OH, 44311-1076, US

(73) Assignee: LINCOLN GLOBAL, INC., City of Industry, CA (US)

(21) Appl. No.: 12/573,312

(22) Filed: Oct. 5, 2009

Related U.S. Application Data
(60) Provisional application No. 61/103,069, filed on Oct. 6, 2008.

(51) Int. Cl. B05D 3/06; B05C 19/00

(52) U.S. Cl. 427/554; 427/532; 427/557; 118/641

(57) ABSTRACT

In a laser cladding, a diamond particulate is applied to the base material of an article that has been melted by an energy source such as a laser. The particulates are introduced into the molten material and allowed to settle as the article surface cools and solidifies. The diamond particulates function to increase the wear resistant characteristics of the article. In one embodiment, the diamond particulates are covered with a metallic veneer, which may be tungsten.

This utility patent application claims priority to U.S. provisional patent application Ser. 61/103,069 filed on Oct. 6, 2008, entitled Methods and Materials for Laser Cladding, which is incorporated herein by reference in its entirety.

### TECHNICAL FIELD

The present invention pertains generally to methods and materials used in laser cladding metallic articles, and more particularly, to incorporating additives that improve the wear resistance of the articles.

### BACKGROUND OF THE INVENTION

Metal parts frequently fail their intended use, due not only to fracturing but also to wear and abrasion. Wear changes a metal part dimensionally and as such functionally. Processes are known for repairing worn metal parts where durable material is adhered to the abraded surface. Laser cladding is one such process. The manufacturing sector also uses laser cladding to adhere hard material onto relatively softer material for improved wear resistance and durability. In laser cladding, a concentrated beam of energy is impinged on the surface of a given article melting an outer layer of material. A powder is then injected or deposited onto the melted surface where the particulates combine with the substrate.

### BRIEF SUMMARY

In one embodiment of the subject invention, a method of cladding an associated article includes the steps of directing a source of energy having enough power to melt at least a portion of an associated article and infusing mineral granules into the at least a portion of the associated article where the mineral granules may be diamonds or corundum granules. In another embodiment of the subject invention a method of laser cladding an associated metallic article includes the steps of providing and activating a laser having a beam of energy that impinges the surface of the associated metallic article, directing the laser along a trajectory thereby creating a molten puddle on a surface of the associated metallic article, and depositing non-metallic, crystalline particulates into the molten puddle where the non-metallic, crystalline particulates may be diamonds or corundum granules.

### BRIEF DESCRIPTION OF THE DRAWINGS

FIG. 1 is a perspective view of a laser melting the surface of a rounded article in accordance with the embodiments of the subject invention.

FIG. 2 is a perspective view of a laser melting the surface of a planar article where diamond particulates are being added to the substrate in accordance with the embodiments of the subject invention.

FIG. 3 is a side view of a laser cladding process depositing diamond particulates into a substrate, in accordance with the embodiments of the subject invention.

FIG. 3a is a side view of a cladding process depositing diamond particulates into a substrate using a welding power supply, in accordance with the embodiments of the subject invention.

FIG. 4 is a perspective view of several wear resistance particulates, which may be diamond particulates, covered by a veneer, in accordance with the embodiments of the subject invention.

FIG. 5 is a cross-sectional close up view of a wear resistant particulate embedded in a substrate layer, in accordance with the embodiments of the subject invention.

FIG. 6 is a schematic representation of an article showing applied cladding material having wear resistant particulates embedded therein, in accordance with the embodiments of the subject invention.

FIG. 7 is a block diagram of a method of increasing the wear resistant characteristics of an associated article, in accordance with the embodiments of the subject invention.

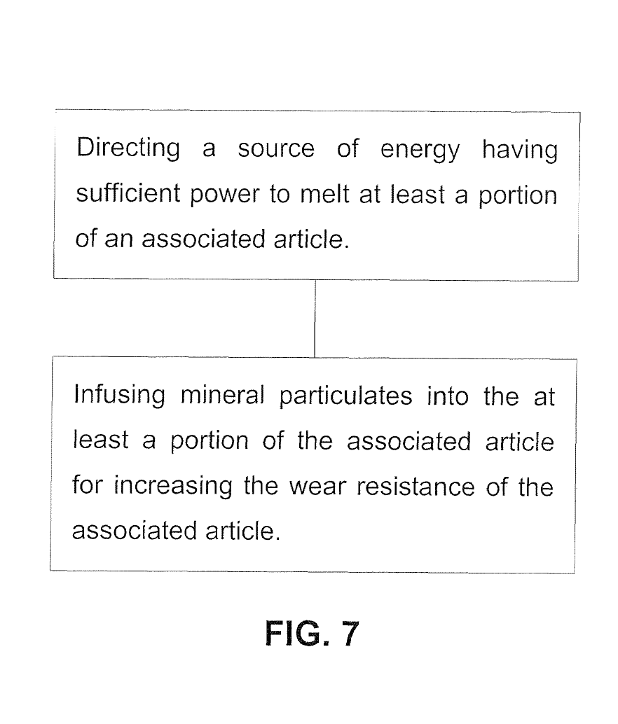

FIG. 8 is a block diagram of a method of laser cladding an associated metallic article, in accordance with the embodiments of the subject invention.

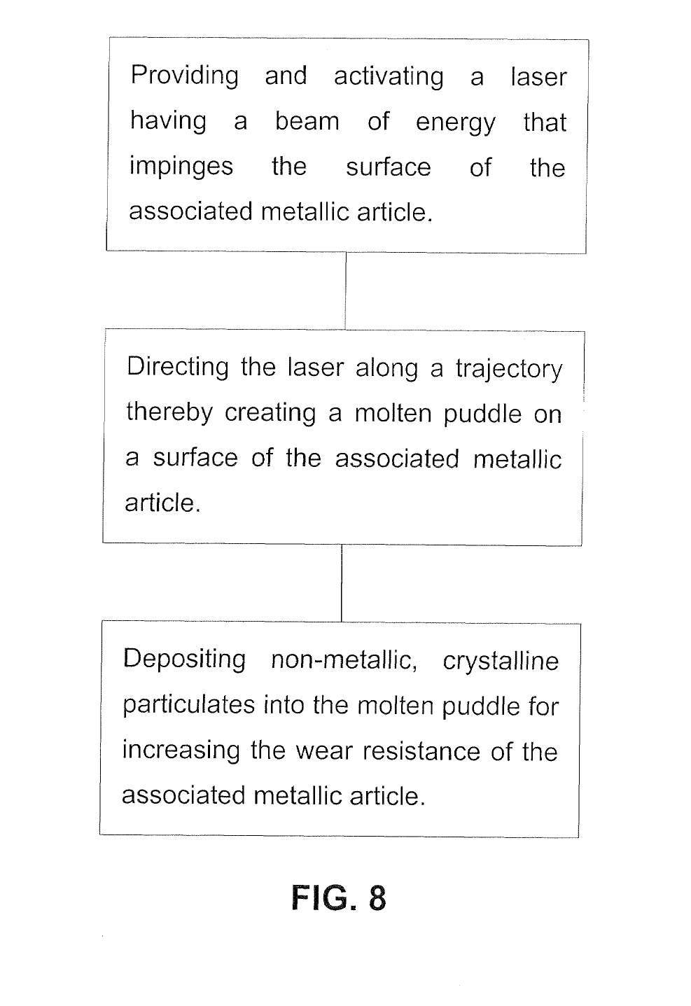

### DETAILED DESCRIPTION OF THE INVENTION

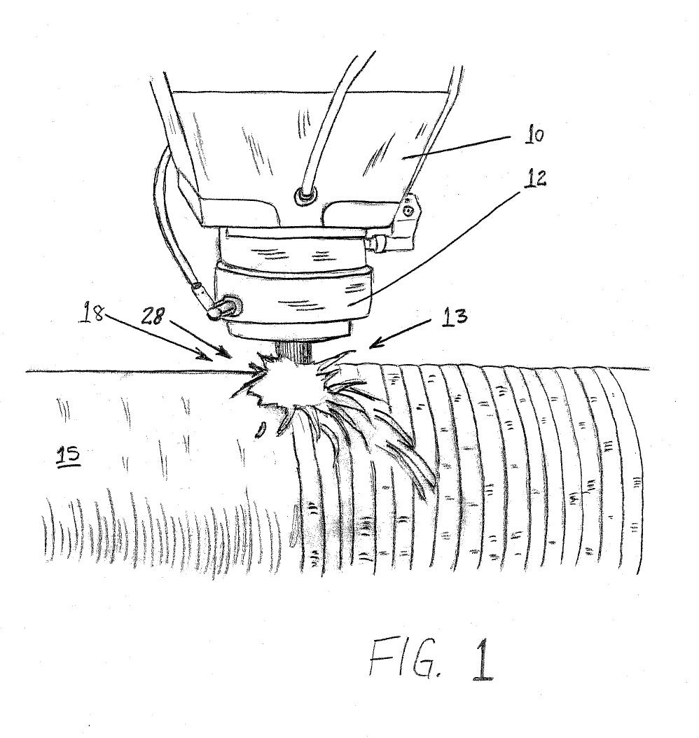

Referring now to the drawings wherein the showings are for purposes of illustrating embodiments of the invention only and not for purposes of limiting the same, FIG. 1 depicts an energy source 10 used in cladding the surface of an associated article 15. The energy source 10 may deliver power in any of various forms as derived from for example electrical current, and/or electromagnetic radiation in the form of amplified light. In one embodiment, the energy source 10 is a laser 12, although other sources of energy like an arc welding power supply 16 may be utilized without departing from the intended scope of coverage of the embodiments of the subject invention. The energy source 10 may direct energy onto the surface of the article 15 thereby melting an outer layer of material. The ensuing molten puddle 28 is then infused with one or more substances for increasing the wear resistance of the article 15 as will be discussed in detail below. In the solidified state, the substances, engrained into the substrate, function to resist abrasion and deterioration during use of the article 15.

Generally the embodiments of the subject invention pertain to metallic articles, although similar methods may be used for non-metallic components. Accordingly, article 15 may be comprised of a base metal such as iron and may be constructed from sheet steel, steel plate, or round stock. The methods and processes described herein may also be applied to alloyed metals, like aluminum or any other alloy chosen with sound engineering judgment. Applications of the embodiments of the subject invention include but are not limited to the repair or resurfacing of worn or damaged parts, the application of coatings on component surfaces and additive manufacturing, to name a few.

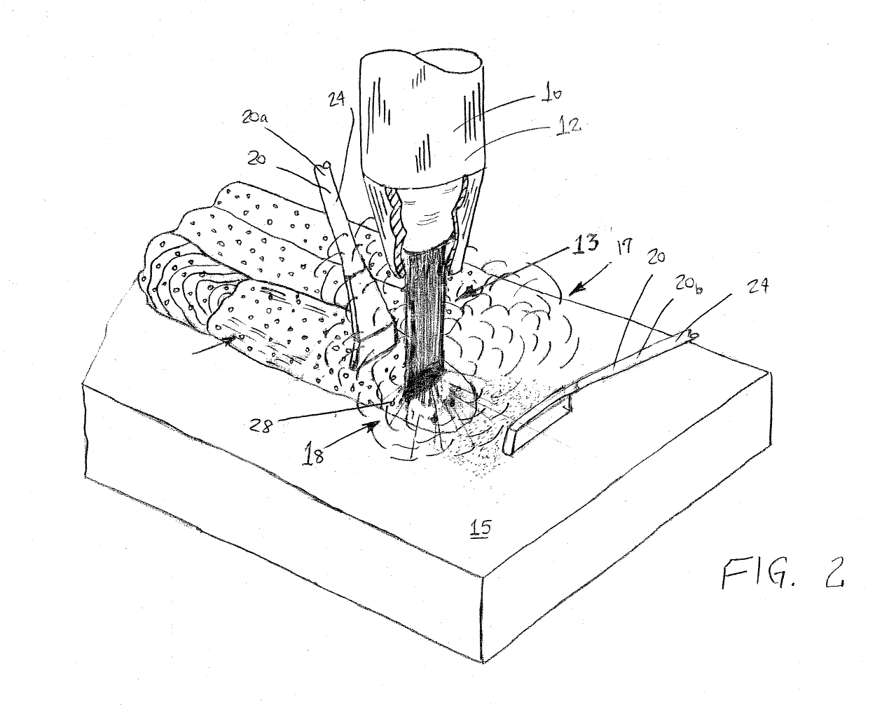

With reference to FIGS. 1 and 2, laser 12, which may be a direct diode laser 12, directs energy at a designated rate to melt an outer portion of article 15. The amount of material melted, i.e. its thickness or depth, is dependant in part on the intensity of the energy beam 13 and its dwell time, along with other factors like the composition of the base material. The laser 12 may traverse a pathway covering the article surface or select portions of the article surface. In one embodiment, the laser 12 may have characteristic beam width, which may be in the range between 0 mm and 15 mm. More specifically, the beam width may be substantially 12 mm. However, it is to be construed that other configurations of lasers, including but not limited to spot lasers, may be utilized without departing from the intended scope of coverage of the embodiments of the subject invention. Accordingly, a trajectory may be chosen that takes into account the width of the beam 13, the power rate and the travel speed of the laser beam 13 relative to the surface of article 15. Of course, persons skilled in the art will readily understand that one or both of the laser 12 and article 15 may move relative to the other at any rate suitable for melting a surface of article 15.

In one particular embodiment of the subject invention, a shielding gas 17 may be dispensed in conjunction with the laser beam 13. In this manner, the surface of the article 15 may be shrouded or showered with a gas 17, which may be an inert gas 17, to minimize interaction of the melt zone 18 with the atmosphere. Adverse phenomena, specifically the formation of a plasma cloud, can occur at the point of interaction between the laser beam 13 and the surface being treated. The plasma cloud absorbs and reflects part of the beam 13, and tends to defocus the remaining portion of the beam 13 thereby lessening its intensity. Accordingly, a flowing inert gas 17 is provided to flood the region surrounding the laser beam 13 and hence the melt zone 18. Examples of gas 17 used include: Helium, Argon, and combinations thereof. However, the aforementioned list is not to be construed as limiting. Rather, any type of gas may be used that effectively prevents the formation of a plasma cloud, as well as other adverse effects. The gas 17 may be dispensed from the same nozzle as that of the laser beam 13. Alternatively, a separate nozzle, not shown, may be used to dispense the gas 17 and flood the melt zone 18 in a manner consistent with that described above. Still, any means of dispensing a shielding gas 17 may be chosen with sound engineering judgment.

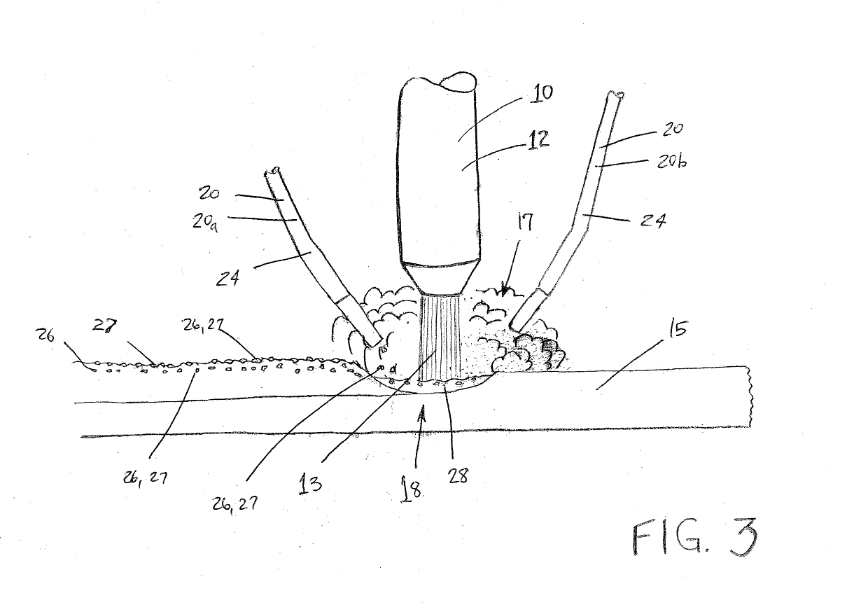

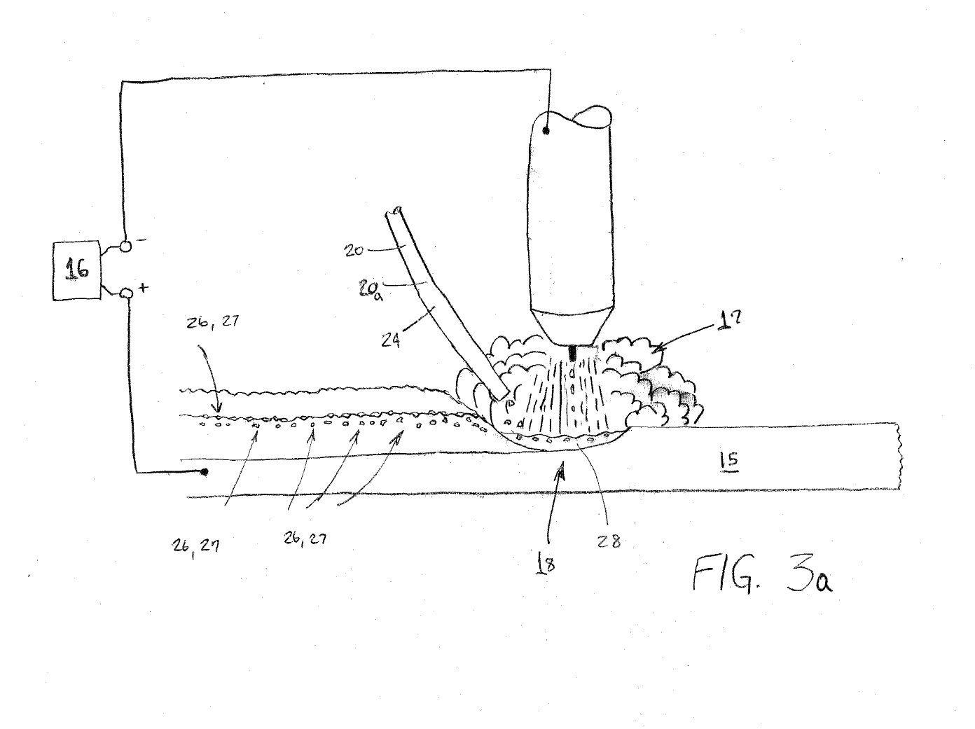

With continued reference to FIG. 2 and now also to FIG. 3, a feeder 20 may be used to deposit a substance or substances onto the surface of article 15 for infusing with the molten material of article 15. In one embodiment, the feeder 20 may use gravity to dispense the substances. The feeder 20 may incorporate one or more components that make up a gravity feed mechanism. A tubular member 24 may be utilized that directs material from a feed source, not shown, to a point in or near the molten puddle 28. The tubular member 24 may be adjustable with respect to its position behind the laser 12 or laser beam 13. It will be appreciated that the tubular member 24, also termed feed tube, may be positioned at any position relative to the melt zone 18 as is appropriate for use with the embodiments of the present invention. Alternatively, the feeder 20 may propel the substances onto the surface of the article 15 or inject the substances into the molten puddle 28 by using a pressurized medium, like for example inert gas 17. Still, any device or method of dispensing substances used in the cladding process may be chosen without departing from the intended scope of coverage of the embodiments of the subject invention.

In one particular embodiment, multiple feeders 20ₐ, 20_{b} may be used to dispense substances onto the surface of article 15. The feeders 20ₐ, 20_{b} may deposit the same or different materials. In an exemplary manner, feeder 20ₐ may dispense a crystalline particulate, which may be diamond particulates 27, used to increased the wear resistant characteristics of article 15. Similarly, feeder 20_{b} may dispense another particulate, which may include for example cladding particulates or other matter suitable for use in the cladding process. The feeders 20ₐ, 20_{b} may be positioned at various locations in relation to the laser 12, and more particularly in relation to the impinging beam 13 on the surface of article 15. In particular, the feeders 20ₐ, 20_{b} may be fixedly positioned with respect to the laser 12 and, more specifically, may be rigidly connected to the laser 12 by any suitable means chosen with sound engineering judgment. In an exemplary manner, feeder 20ₐ may be positioned in front of beam 13, i.e. ahead of the laser beam 13 in relation to its direction of travel, while feeder 20_{b} may be situated behind the beam 13. Still, the feeders 20ₐ, 20_{b} may be positioned at any location and distance from the beam 13 and/or melt zone 18 as chosen with sound engineering judgment.

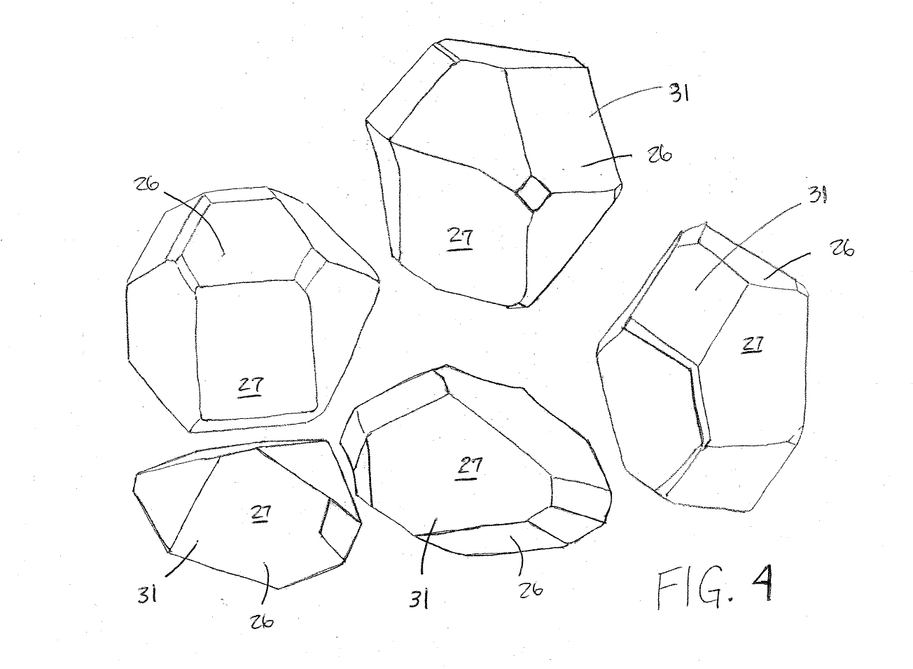

With continued reference to FIGS. 2 and 3 and now also to FIG. 4, the substances dispensed from feeder 20 may function to increase the wear resistant characteristics of article 15. In one embodiment, the substances, referred to herein as wear resistant particulates 26, may be comprised of a mineral substance. It is contemplated in one embodiment that the mineral substance may be substantially nonmetallic in nature; that is to say comprised mostly of elements that are categorized as nonmetallic. The wear resistant particulates 26 may also be substantially elemental in its construction. Additionally, in its solid phase, the mineral substance may be crystalline in nature. More specifically, the microscopic configuration of the crystalline lattice structure may be configured isometrically, which is to say that the lattice structure is arranged in an array of points repeating periodically in three dimensions. In one embodiment, the wear resistant particulates 26 may be comprised mostly of carbon atoms, which in the aforementioned configuration, is more commonly known as diamond 27. It is known in the art that diamond substances are not necessarily comprised completely or purely of carbon. Rather other elements may be interspersed into the lattice structure like for example nitrogen, which is known to give diamond substances a yellow hue. It is to be construed that all such variations are to be included within the scope of coverage of the embodiments of the subject invention.

Other embodiments are contemplated wherein the wear resistant particulates 26 are comprised of mineral substances including compounds other than or in addition to diamond 27. Such mineral substances may similarly have a lattice structure that is isometrically configured. One type of mineral is made from Aluminum Oxide commonly called corundum. Examples of such wear resistant particulates 26 may include sapphires, rubies and the like. In this manner, the mineral substances may be characterized as gemstones and may be substantially homogenous in configuration. Mineral substances such as those described herein may include various quantities of foreign particulates, which may be encased by the lattice structure or incorporated into the lattice structure. Again, all such compounds are to be construed as falling within the scope of coverage of the embodiments of the subject invention.

The wear resistant particulates 26 may be relatively small in diameter ranging in size from approximately 100μ (microns or micrometers) up to and exceeding 800μ (microns or micrometers). More specifically, the wear resistant particulates 26 may be in the range substantially between 400μ (microns or micrometers) to 600μ (microns or micrometers). However, the wear resistant particulates 26 may be somewhat larger or smaller than the stated ranges. In an exemplary manner, the figures depict generally circular or elliptically shaped particulates, although the wear resistant particulates 26 may also be elongate or have any shape as is appropriate for use with the embodiments of the subject invention.

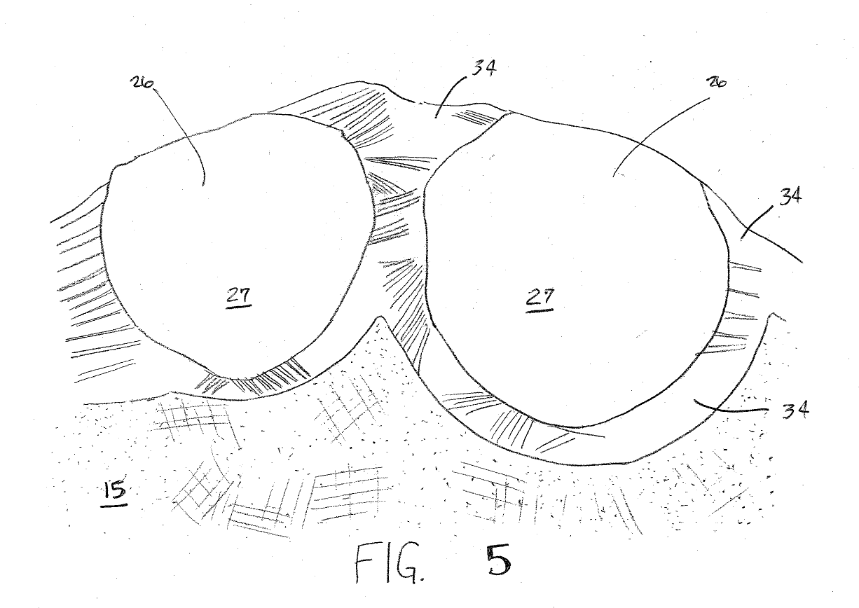

With continued reference to FIGS. 4 and 5, another embodiment is contemplated wherein the wear resistant particulates 26 may be at least partially covered or coated with a veneer 31. The veneer 31, or coating 31, may be comprised of metal or metal alloy. The metal or metal alloy may itself be hard or wear resistant. Additionally, the material comprising the veneer 31 may correspond to the base material of article 15. That is to say that the material comprising the metallic veneer 31 may effectively blend together with the base material of article 15. In one example, the veneer 31 is comprised of tungsten or tungsten carbide. Tungsten, once exposed to the energy source of the laser beam 13 and/or heat from molten puddle 28, melts forming a tungsten carbide substrate 34 within which the wear resistant particulates 26 become embedded. Other embodiments are contemplated wherein the veneer 31 is comprised of cobalt, chromium and/or alloys formed therefrom. Still, the veneer 31 may be comprised of any metal as is appropriate for use with the embodiments of the subject invention.

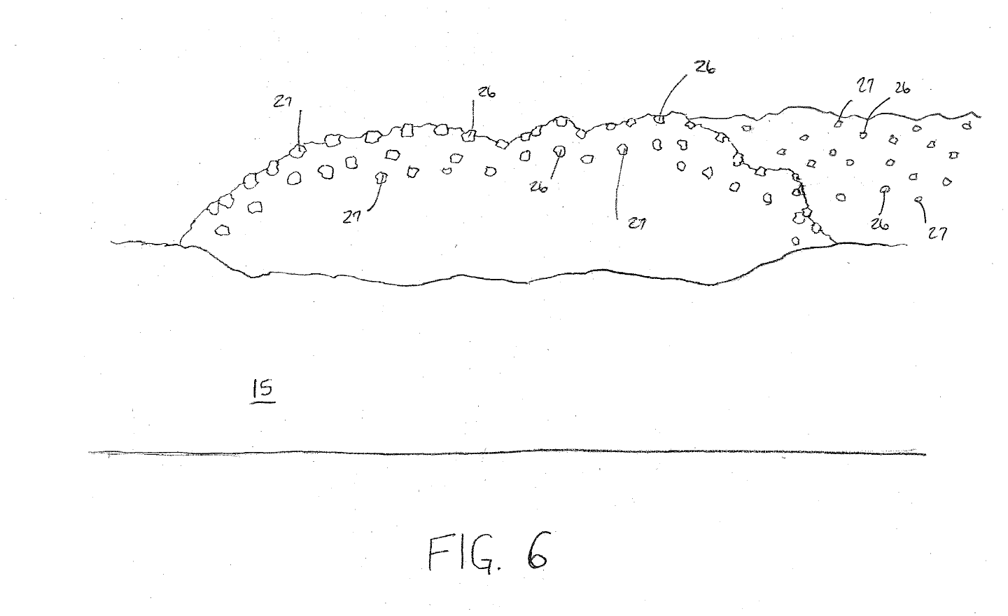

With reference now to FIG. 6, in one embodiment, the type and/or amount of veneer 31 may be selectively adjusted to change the overall density of the wear resistant particulates 26. In the example of diamond particulates 27, it will be understood that diamonds 27 are substantially homogeneous having a generally uniform density. As such, uncoated diamond particulates 27 will penetrate only so far into the molten puddle 28 regardless of its size. To increase penetration into the molten puddle 28, the amount of veneer 31 may be changed to increase the overall density of the particulate 26 allowing it to settle deeper into the molten puddle 28. In one example, the thickness of the veneer 31 may range from just one micrometer up to 50 micrometers. However, any thickness of veneer 31 may be chosen as is appropriate for use with the embodiments of the present invention. It will also be realized that the rate of cooling of the molten puddle 28 and its viscosity, which changes with the distance from the melt zone, may affect how deep the wear resistant particulates 26 settle into the molten puddle 28. Accordingly, the position of tubular member 24 may be adjusted to achieve any desired settling depth of the wear resistant particulates 26. Persons of skill in the art will further appreciate that some of the wear resistant particulates 26 may be manufactured having different veneer thicknesses, and thus different densities, than other wear resistant particulates 26. When combined and dispensed together, the wear resistant particulates 26 settle at different depths. By adjusting the proportion of lighter to heavier density particulates, the end-user may effectively distribute the wear resistant particulates 26 through a range of depths within the substrate. All such proportions are to be construed as falling within the scope of coverage of the embodiments of the subject invention.

The invention has been described herein with reference to the disclosed embodiments. Obviously, modifications and alterations will occur to others upon a reading and understanding of this specification. It is intended to include all such modifications and alterations insofar as they come within the scope of the appended claims or the equivalence thereof.

What is claimed is:

1. A method of increasing the wear resistance an associated article, comprising the steps of:
directing a source of energy having sufficient power to melt at least a portion of an associated article; and,
infusing mineral particulates into the at least a portion of the associated article for increasing the wear resistance of the associated article.

2. The method as defined in claim 1, wherein the mineral particulates are comprised of: diamond.

3. The method as defined in claim 1, wherein the mineral particulates are comprised of: corundum particulates.

4. The method as defined in claim 1, wherein the associated article includes a surface area that is at least partially metallic; and,
wherein the source of energy is a source of electromagnetic radiation having sufficient power to melt at least a portion of the metallic surface area of the associated article.

5. The method as defined in claim 4, wherein the step of directing a source of energy comprises the step of:
directing a source of energy having sufficient power to melt at least a portion of the metallic surface area thereby forming a molten puddle; and wherein the step of infusing mineral particulates, comprises the step of:
depositing mineral particulates into the molten puddle.

6. The method as defined in claim 1, wherein the size of mineral particulates range from between 100 micrometers to 800 micrometers.

7. The method as defined in claim 1, wherein the size of mineral particulates range from between 400 micrometers to 600 micrometers.

8. The method as defined in claim 1, wherein the source of energy is amplified light.

9. The method as defined in claim 1, wherein the source of energy is derived from a welding power supply.

10. A method of laser cladding an associated metallic article, comprising the step of:
providing and activating a laser having a beam of energy that impinges the surface of the associated metallic article;
directing the laser along a trajectory thereby creating a molten puddle on a surface of the associated metallic article; and,
depositing non-metallic, crystalline particulates into the molten puddle for increasing the wear resistance of the associated metallic article.

11. The method as defined in claim 10, wherein at least a portion of the non-metallic, crystalline particulates have an isometrically configured lattice structure.

12. The method as defined in claim 10, wherein the non-metallic, crystalline particulates are comprised of diamond particulates.

13. The method as defined in claim 10, wherein the non-metallic, crystalline particulates are comprised of corundum particulates.

14. The method as defined in claim 10, wherein the non-metallic, crystalline particulates are deposited into the molten puddle at a location behind the beam of energy.

15. The method as defined in claim 14, wherein the location behind the beam of energy is in the range substantially between 0 inch and 1 inch.

16. The method as defined in claim 10, wherein at least some of the non-metallic, crystalline particulates are at least partially covered with a veneer.

17. The method as defined in claim 16, wherein the veneer is comprised of at least one of: tungsten, cobalt or chromium.

18. A system for metal cladding, comprising:
a laser having sufficient power to melt at least a surface portion of an associated metallic article; and,
a feeder for depositing diamond particulates.

19. The system as defined in claim 18, wherein the feeder is fixed in positioned with respect to the laser for depositing diamond particulates into a melted surface portion of the associated metallic article; and further comprising:
a second feeder for depositing cladding particles onto an un-melted surface of the associated metallic article.

20. The system as defined in claim 19, further comprising:
means for dispensing a gas for at least partially covering that region of the associated metallic article melted by the laser.
